(19) United States
(12) Patent Application Publication
(10) Pub. No.: US 2019/0111728 A1
(43) Pub. Date: Apr. 18, 2019

(54) METAL ARTICLE HAVING DECORATIVE GRAPH-TEXT AND PREPARATION METHOD THEREOF

(71) Applicant: BYD COMPANY LIMITED, Shenzhen, Guangdong (CN)

(72) Inventors: Fuhua LUO, Shenzhen (CN); Jiang YUAN, Shenzhen (CN); Jihou WANG, Shenzhen (CN); Liang CHEN, Shenzhen (CN)

(73) Assignee: BYD COMPANY LIMITED, Shenzhen, Guangdong (CN)

(21) Appl. No.: 16/099,580

(22) PCT Filed: May 4, 2017
(86) PCT No.: PCT/CN2017/083110

§ 371 Date: Nov. 7, 2018

(30) Foreign Application Priority Data
May 30, 2016 (CN) 201610367093.0

(51) Int. Cl. B44C 1/17

(52) U.S. Cl. CPC B44C 1/1704

(57) ABSTRACT

The present disclosure provides a metal article having decorative graph-text. The metal article comprises includes a metal substrate having micropores on the surface, thermal sublimation ink filled in a portion of the micropores, and a pore-sealing layer located on the surface of the metal substrate. The present disclosure also provides a preparation method for a metal article having decorative graph-text.

### CROSS-REFERENCE TO RELATED APPLICATION

The present application is a 371 Application of International Application No. PCT/CN2017/083110, filed on May 4, 2017, which claims priority of Chinese Patent Application No. 201610367093.0 filed in China on May 30, 2016, the entire contents of which are hereby incorporated by reference.

### TECHNICAL FIELD

The present disclosure belongs to the field of metal decoration, and more particularly, the present disclosure relates to a metal article having decorative graph-text and a preparation method thereof.

### BACKGROUND ART

With the rapid development of the mobile electronic technology industry in recent years, the function of electronic devices is not the only goal pursued by consumers. The appearance of electronic devices, such as mobile phone housing, also attracts the attention of public, while the mobile phone housing having metallic gloss and color is often more capable to meet people's requirements for aesthetics. Therefore, the development of these appearances technologies has become an irreplaceable part of the decoration of electronic products such as mobile phones.

The current technical solution for achieving the graph-text decoration on the metal surface is: the first step, spraying a coating on the metal surface; the second step, printing thermal sublimation ink onto thermal sublimation paper; the third step, bringing the printed thermal sublimation paper into contact with the coating surface on the metal; and the fourth step, heating by a hot stamping machine or other heating methods and adsorbing the thermal sublimation ink with the coating, thereby transferring the graph-text from the thermal sublimation paper onto the metal product.

Because the product prepared by the technical method stated above requires spraying one layer of coating on the metal surface, and the surface coating masks the inherent metal texture of the metal, resulting in that the metal product loses the inherent metal texture.

### SUMMARY OF THE INVENTION

The present disclosure is directed to the problems described above, thereby providing a metal article having a metallic texture and a preparation method thereof.

The present disclosure provides a metal article having decorative graph-text, and the metal article comprises a metal substrate having micropores on the surface, thermal sublimation ink filled in a portion of the micropores, and a pore-sealing layer located on the surface of the metal substrate.

The present disclosure also provides a preparation method for a metal article having decorative graph-text, and the method comprises the following steps:

S1, performing micropores treatment on a metal substrate to obtain the metal substrate having micropores on the surface; and printing thermal sublimation ink onto thermal sublimation paper according to the desired graph-text shape;

S2, matching and attaching the graph-text on the thermal sublimation paper to the surface of the metal substrate;

S3, heating the thermal sublimation ink to cause the thermal sublimation ink to enter the micropores on the surface of the metal substrate, so as to form the decorative graph-text;

S4. removing the thermal sublimation paper and sealing pores, thereby obtaining the metal article having decorative graph-text.

The present disclosure also provides a metal article having decorative graph-text prepared by the method.

In the metal article having decorative graph-text of the present disclosure, the graph-text ink is filled in the micropores of the metal surface, then the graph-text ink is sealed in the micropores by pore-sealing, and the graph-text ink has strong adhesion, and is not easy to cause color deterioration. At the same time, the metallic gloss is retained.

In the method of the present disclosure, by attaching the thermal sublimation paper with graph-text to the surface of the metal substrate, and then by oven-drying to cause the thermal sublimation ink to enter the micropores of the metal surface, the graph-text is formed, while the inherent metallic gloss of the metal is retained.

Other features and advantages of the present disclosure will be described in detail in the following specific embodiment.

### SPECIFIC EMBODIMENT

In order to illustrate the technical problems, technical solutions and beneficial effects of the present disclosure more clearly, the present disclosure will be further described in detail below with reference to embodiments. It is understood that the specific embodiments described herein are merely intended to illustrate the present disclosure, and are not intended to limit the present disclosure.

The present disclosure provides a metal article having decorative graph-text, and the metal article comprises a metal substrate having micropores on the surface, thermal sublimation ink filled in a portion of the micropores, and a pore-sealing layer located on the surface of the metal substrate.

According to the metal article provided by the present disclosure, the size of the micropores is not particularly limited, as long as the thermal sublimation ink can be allowed to enter. In order to facilitate the entry of the thermal sublimation ink, the micropores have a D50 from 1 nm to 100 μm, alternatively 5 nm to 20 μm, for example 10 nm to 1 μm.

In the present disclosure, the shape of the micropores is not particularly limited, and may be monolayer pores, or may be double layers pores or multiple layers pores, as long as the D50 of the micropores on the surface is 1 nm to 100 μm.

According to the metal article provided by the present disclosure, in order to enhance later pore-sealing effect, alternatively, the micropores have a depth from 10 nm to 100 μm, alternatively 1 μm to 50 μm, for example 5 μm-30 μm.

According to the metal article provided by the present disclosure, the metal substrate is not particularly limited, as long as it is general commonly used metal, for example, it can be one of an aluminum alloy, stainless steel, and a magnesium alloy.

In the metal article of the present disclosure, the graph-text ink is filled in the micropores of the metal surface, and then the graph-text ink is protected in the micropores by pore-sealing, and the graph-text ink has strong adhesion, and is not easy to cause color deterioration. At the same time, the metallic gloss is retained.

The present disclosure also provides a preparation method for a metal article having decorative graph-text, and the method comprises the following steps:

S1, performing micropores treatment on a metal substrate to obtain the metal substrate having micropores on the surface; and printing thermal sublimation ink onto thermal sublimation paper according to a desired graph-text shape;

There is no limitation on the order of performing the micropores treatment on the metal substrate and printing the thermal sublimation ink onto the thermal sublimation paper according to the desired graph-text shape. It can be first performing the micropores treatment on the metal substrate and then printing the thermal sublimation ink onto the thermal sublimation paper according to the desired graph-text shape; or can be first printing the thermal sublimation ink onto the thermal sublimation paper according to the desired graph-text shape and then performing the micropores treatment on the metal substrate; alternatively, it can also be printing the thermal sublimation ink onto the thermal sublimation paper according to the desired graph-text shape and performing the micropores treatment on the metal substrate at the same time.

S2, matching and attaching the graph-text on the thermal sublimation paper to the surface of the metal substrate;

The attaching referred herein can be understood as adhering to the surface of the metal substrate, and in order to ensuring that the ink graph-text can be more accurately retained as the original graph-text shape, the attaching referred herein is required to be closer attaching.

S3, heating the thermal sublimation ink to cause the thermal sublimation ink to enter the micropores on the surface of the metal substrate, so as to form the decorative graph-text;

The thermal sublimation ink is sublimated under heating, and since the thermal sublimation paper is attached to the surface of the metal substrate, the thermal sublimation ink is sublimated and then correspondingly enters into the corresponding micropores of the metal substrate surface, so that the decorative graph-text as same as the graph-text on the thermal sublimation paper can be formed on the metal substrate surface.

S4. removing the thermal sublimation paper and sealing pores, thereby obtaining the metal article having decorative graph-text.

After the thermal sublimation ink enters the micropores, the micropores are subjected to pore-sealing. On one hand, the metal surface can be smoothed, and on the other hand, the decorative graph-text can be better protected.

According to the preparation method provided by the present disclosure, in order to ensure that the thermal sublimation paper is more closely attached to the metal substrate, alternatively, before step S3, it can further comprise placing the metal substrate to which the thermal sublimation paper is attached into a sealing apparatus and vacuuming the sealing apparatus. By vacuuming, the thermal sublimation paper can be smoothly and closely attached to the surface of the metal substrate of any shape, and there is no limitation on the shape of the metal substrate, for example, the metal substrate can be curved, so that 3D decorative graph-text can be formed on the metal substrate surface. The 3D decorative graph-text can better meet the aesthetic requirements of consumers. It can be widely applied to the housing of electronic products.

According to the preparation method provided by the present disclosure, the method of the micropores treatment is not particularly limited, and may be various micropores treatment methods commonly used in the art, as long as the desired micropores can be obtained, for example, it can be one or two combination treatment methods selecting from phosphating treatment, silanization treatment, anodizing treatment, and etching treatment.

In the present disclosure, the phosphating treatment is: immersing the metal substrate into a phosphating solution composed of 40 g/L of iron dihydrogen phosphate, 20/L of manganese dihydrogen phosphate and 40 g/L of zinc dihydrogen phosphate, wherein, the pH value is 2; and treating at 50° C. for 15 minutes. The D50 of the micropores obtained by the phosphating treatment is generally between several nanometers and tens of nanometers, and the thickness of the formed film is 0.1 μm to 50 μm.

In the present disclosure, said silanization treatment is: placing the metal substrate in a 60%-70% ethyltriethoxysilane solution, adjusting the pH to be 8-9 with glacial acetic acid; soaking for 30 minutes, and then taking out and placing into a thermostatic drying chamber at 80° C. for baking for 1 hour. The D50 of the micropores obtained by the silanization treatment is generally between several nanometers and tens of nanometers, and the formed film has a thickness from 0.1 μm to 50 μm.

In the present disclosure, the anodizing treatment is: immersing the metal substrate into an anolyte (composed of 160 g/L of sulfuric acid), and controlling the current density to be 1.3 A/dm² at 25° C. for treating for 20 minutes.

In the present disclosure, the etching process may be simple acid etching or alkali etching, or may be acid etching or alkali etching after anodizing. In the present disclosure, the etching treatment is: pre-treating the metal substrate with a sulfuric acid solution, wherein the conditions includes sulfuric acid concentration of 10%-15%; a voltage of 12-15V; soaking time of 10-20 min, thereby forming the metal substrate with irregular surface and corrosion pores; and then placing the pre-treated metal substrate into a alkali etching solution for electrochemical corrosion, wherein the concentration of the corrosion solution is 5%-10%, and the soaking time is 5-10 min, thereby forming finer pores on the metal substrate with corrosion pores.

According to the preparation method provided by the present disclosure, the size of the micropores is not particularly limited, as long as the thermal sublimation ink can be allowed to enter. In order to facilitate the entry of the thermal sublimation ink, alternatively, the D50 of the micropores is 1 nm to 100 alternatively 5 nm to 20 for example 10 nm to 1 The shape of the micropores is not particularly limited, and may be single layer pores, or may be double layers pores or multiple layers pores, as long as the D50 of the micropores on the surface is 1 nm to 100 μm.

According to the preparation method provided by the present disclosure, in step S3, the method for heating the thermal sublimation ink is to bake the sealing apparatus. In order to help the thermal sublimation ink to enter the micropores, alternatively, in step S3, the baking temperature is 80° C.-240° C., and the alternative baking temperature is 120-180° C.; the baking time is 2-360 minutes, and the alternative baking time is 30 minutes-1 hour.

According to the preparation method provided by the present disclosure, the pore-sealing method is not particularly limited, and may be various pore-sealing methods commonly used in the art, such as pore-sealing with water or with a sealing agent. The pore-sealing with water is: placing the metal substrate having formed with the micropores on the surface into hot water of 95° C. and soaking for 30 minutes. The pore-sealing with the sealing agent is: immersing the metal substrate having formed with the micropores on the surface with a pore-sealing agent solution of 6% nickel acetate for 20 min at 95° C.

According to the preparation method provided by the present disclosure, the metal substrate further includes an oven-drying step after the micropores treatment, and the effect of said oven-drying is to ensure that there is no moisture content in the micropores, so as to promote the thermal sublimation ink to permeate the micropores subsequently. The temperature of the oven-drying is 80-100° C.

According to the preparation method provided by the present disclosure, the metal substrate is one of metal materials such as an aluminum alloy, stainless steel, a magnesium alloy and the like.

In the present disclosure, the thermal sublimation paper to be used is not particularly limited, and can be various thermal sublimation paper commonly used in the art, for example, the paper having a thickness of 0.09 mm which is commonly used in the art can be selected.

In the present disclosure, the melting point of the sealing apparatus is not particularly limited, as long as it is higher than the baking temperature, and alternatively, the melting temperature of the sealing apparatus is 260° C. or higher. The sealing apparatus is not particularly limited, as long as it can seal the thermal sublimation paper. In the present disclosure, the sealing apparatus is a vacuumed soft silica gel sealed bag, and the melting temperature of the silica gel is 260° C. or higher.

In the present disclosure, before the micropores treatment, it further comprises the steps of subjecting the metal surface to degreasing, decontaminating, and derusting and washing. The degreasing, decontaminating, and derusting and washing can be various methods commonly used in the art, for example, comprising: sequentially immersing the metal substrate into the RC-800 type derusting agent solution, then washing with water, subsequently immersing into the SP-101 type degreasing agent solution, and finally rinsing with pure water.

The present disclosure also provides a metal article having decorative graph-text prepared by the preparation method described in the present disclosure.

In the method of the present disclosure, the thermal sublimation paper to which the graph-text is adhered is smoothly attached to the surface of the metal substrate by vacuuming, therefore, there is no requirement for the metal substrate, and a curved face of graph-text can be formed. At the same time, the thermal sublimation ink is allowed to enter the micropores of the metal surface by oven-drying, and the metallic gloss would not be affected.

The present disclosure is further described in detail below through specific embodiments.

### EXAMPLE 1

Achieving 3D decorative graph-text on a surface of a magnesium alloy comprises the following steps:

1) first, pre-treating the magnesium alloy material with curved surface, subjecting the surface of the magnesium alloy to oil and contamination cleaning with SP-101 type degreasing agent, RC-800 type derusting agent and water respectively, so as to expose the bright surface of the magnesium alloy; and then baking at 90° C. for 30 minutes;
2) subjecting the cleaned magnesium alloy to a micropores treatment, wherein the specific method of the micropores treatment is: immersing the metal substrate into a phosphating solution composed of iron dihydrogen phosphate, manganese dihydrogen phosphate and zinc dihydrogen phosphate according to 2:1:2, adjusting the pH value to be 2, and performing the treatment at 50° C. for 15 minutes; thereby obtaining the micropores with D50 of 1 μm and a depth of 50 μm after the treatment;
3) adjusting the temperature of the oven to be 90° C., and baking the micropores treated magnesium alloy substrate for 30 minutes;

4) taking a piece of thermal sublimation paper with a thickness of about 0.09 mm, and printing thermal sublimation ink on the thermal sublimation paper to form the desired graph-text;

5) taking the oven-dried magnesium alloy substrate, and attaching the graph-text on the thermal sublimation paper to the magnesium alloy substrate with the matched position;
6) placing the magnesium alloy substrate to which the thermal sublimation paper is attached in a sealing apparatus, and vacuuming (with a vacuum degree of 0.05 Pa), so that the sealing apparatus allows the thermal sublimation paper to be closely and omnidirectionally attached to the front face and the lateral face of the magnesium alloy member;
7) placing the sealing apparatus into a baking oven having been heated, wherein the baking temperature is 120 ° C., and the baking time is 240 minutes;
8) after baking, naturally cooling, taking out the magnesium alloy member, removing the attached thermal sublimation paper, placing the transferred magnesium alloy member in pure water, heating at 95 ° C. for 30 minutes for a pore-sealing treatment, then washing with water, subsequently baking in the oven at 90 ° C. for 30 minutes, and oven drying; thereby obtaining the metal article A1 of the present disclosure.

### EXAMPLE 2

Achieving 3D decorative graph-text on a surface of stainless steel comprises the following steps:

1) first, pre-treating the stainless steel material with curved surface, subjecting the surface of the aluminum alloy to oil and contamination cleaning with SP-101 type degreasing agent, RC-800 type derusting agent and water respectively, so as to expose the bright surface of the stainless steel; and then baking at 90° C. for 30 minutes;
2) subjecting the cleaned stainless steel to a micropores treatment, wherein the specific method of the micropores treatment is: placing the metal substrate in a 65% ethyltriethoxysilane solution, adjusting the pH to be 8 with glacial acetic acid; soaking for 30 minutes, and then taking out and placing into a thermostatic drying chamber at 80° C. for baking for 1 hour; thereby obtaining the micropores with D50 of 5 μm and a depth of 10 μm after the treatment;
3) adjusting the temperature of the oven to be 90° C., and baking the micropores treated stainless steel substrate for 30 minutes;
4) taking a piece of thermal sublimation paper with a thickness of about 0.09 mm, and printing thermal sublimation ink on the thermal sublimation paper to form the desired graph-text;
5) taking the oven-dried stainless steel substrate, and attaching the graph-text on the thermal sublimation paper to the stainless steel substrate with the matched position;
6) placing the stainless steel substrate to which the thermal sublimation paper is attached in a sealing apparatus, and vacuuming (with a vacuum degree of 0.05 Pa), so that the sealing apparatus allows the thermal sublimation paper to be closely and omnidirectionally attached to the front face and the lateral face of the stainless steel;
7) placing the sealing apparatus into a baking oven having been heated, wherein the baking temperature is 240° C., and the baking time is 2 minutes;
8) after baking, naturally cooling, taking out the stainless steel member, removing the attached thermal sublimation paper, placing the transferred stainless steel member in a pore-sealing agent solution of 6% nickel acetate, soaking at 95° C. for 20 minutes for pore-sealing, then washing with water, subsequently baking in the oven at 90° C. for 30 minutes, and oven drying; thereby obtaining the metal article A2 of the present disclosure.

### EXAMPLE 3

Achieving 3D decorative graph-text on a surface of an aluminium alloy comprises the following steps:

1) first, pre-treating the aluminium alloy material with curved surface, subjecting the surface of the aluminium alloy to oil and contamination cleaning with SP-101 type degreasing agent, RC-800 type derusting agent and water respectively, so as to expose the bright surface of the aluminium alloy; and then baking at 90° C. for 30 minutes;
2) subjecting the cleaned aluminium alloy to a micropores treatment, wherein the specific method of the micropores treatment is: immersing the metal substrate into an anolyte (composed of 160 g/L of sulfuric acid), and controlling the current density to be 1.3 A/dm² at 25° C. for treating for 20 minutes; thereby obtaining the micropores with D50 of 50 nm and a depth of 5 μm after the treatment;
3) adjusting the temperature of the oven to be 90° C., and baking the micropores treated aluminium alloy substrate for 30 minutes;
4) taking a piece of thermal sublimation paper with a thickness of about 0.09 mm, and printing thermal sublimation ink on the thermal sublimation paper to form the desired graph-text;
5) taking the oven-dried aluminium alloy substrate, and attaching the graph-text on the thermal sublimation paper to the aluminium alloy substrate with the matched position;
6) placing the aluminium alloy substrate to which the thermal sublimation paper is attached in a sealing apparatus, and vacuuming (with a vacuum degree of 0.05 Pa), so that the sealing apparatus allows the thermal sublimation paper to be closely and omnidirectionally attached to the front face and the lateral face of the aluminium alloy member;
7) placing the sealing apparatus into a baking oven having been heated, wherein the baking temperature is 80° C., and the baking time is 360 minutes;
8) after baking, naturally cooling, taking out the aluminium alloy member, removing the attached thermal sublimation paper, placing the transferred aluminium alloy member in a pore-sealing agent solution of 6% nickel acetate, soaking at 95° C. for 20 minutes for pore-sealing, then washing with water, subsequently baking in the oven at 90° C. for 30 minutes, and oven drying; thereby obtaining the metal article A3 of the present disclosure.

### EXAMPLE 4

Achieving 3D decorative graph-text on a surface of an aluminium alloy comprises the following steps:

1) first, pre-treating the aluminium alloy material with curved surface, subjecting the surface of the aluminium alloy to oil and contamination cleaning with SP-101 type degreasing agent, RC-800 type derusting agent and water respectively, so as to expose the bright surface of the aluminium alloy; and then baking at 90° C. for 30 minutes;
2) subjecting the cleaned aluminium alloy to a micropores treatment, wherein the specific method of the micropores treatment is: pre-treating the metal substrate with a sulfuric acid solution, wherein, the conditions include sulfuric acid concentration of 10%; voltage of 15V; soaking time of 20min, thereby forming the metal substrate with irregular surface and corrosion pores; and then placing the pre-treated metal substrate into a alkali etching solution for electrochemical corrosion, wherein the concentration of the corrosion solution is 5%-10%, and the soaking time is 10 min, thereby forming finer pores on the metal substrate with corrosion pores; resulting in obtaining the micropores with D50 of 10 nm and a depth of 30 μm after the treatment;
3) adjusting the temperature of the oven to be 90° C., and baking the micropores treated aluminium alloy substrate for 30 minutes;
4) taking a piece of thermal sublimation paper with a thickness of about 0.09 mm, and printing thermal sublimation ink on the thermal sublimation paper to form the desired graph-text;
5) taking the oven-dried aluminium alloy substrate, and attaching the graph-text on the thermal sublimation paper to the aluminium alloy substrate with the matched position;
6) placing the aluminium alloy substrate to which the thermal sublimation paper is attached in a sealing apparatus, and vacuuming (with a vacuum degree of 0.05 Pa), so that the sealing apparatus allows the thermal sublimation paper to be closely and omnidirectionally attached to the front face and the lateral face of the aluminium alloy member;
7) placing the sealing apparatus into a baking oven having been heated, wherein the baking temperature is 190° C., and the baking time is 30 minutes;
8) after baking, naturally cooling, taking out the aluminium alloy member, removing the attached thermal sublimation paper, placing the transferred aluminium alloy member in a pore-sealing agent solution of 6% nickel acetate, soaking at 95° C. for 20 minutes for pore-sealing, then washing with water, subsequently baking in the oven at 90° C. for 30 minutes, and oven drying; thereby obtaining the metal article A4 of the present disclosure.

### Comparative Example 1

Achieving flat decorative graph-text on a surface of an aluminium alloy comprises the following steps:

the first step, spraying a layer of polyurethane coating on the surface of the aluminum alloy with a film thickness of 20 μm;
the second step, printing thermal sublimation ink onto the thermal sublimation paper;
the third step, bringing the printed thermal sublimation paper into contact with the coated surface on the aluminum alloy;
the fourth step, heating at 180° C. by a hot stamping machine, adsorbing the thermal sublimation ink by the coating, so as to transfer the graph-text from the thermal sublimation paper onto the metal product, thereby obtaining the product CA1.

### Comparative Example 2

Achieving 3D decorative graph-text on a surface of an aluminium alloy comprises the following steps:

the first step, spraying a layer of polyurethane coating on the surface of the aluminum alloy with a film thickness of 20 μm;
the second step, printing thermal sublimation ink onto the thermal sublimation paper;
the third step, bringing the printed thermal sublimation paper into contact with the coated surface on the aluminum alloy;
the fourth step, heating at 180° C. by a hot stamping machine, adsorbing the thermal sublimation ink by the coating, so as to transfer the graph-text from the thermal sublimation paper onto the metal product, thereby obtaining the product CA2.

### Performance Tests

### 1 Salt Spray Test

1) Placing the products A1-A4 and CA1-CA2 in a salt spray case, and spraying continuously for 2 hours at temperature of +35° C. (NaCl solution concentration: 5%, pH being 6.5-7.2, supply air pressure being 10-25 psi, spray rate being 0.75-3 c.c./80cm2.hr);
2) After spraying, conveying the sample to a storage case with a temperature of +40° C. and a relative humidity of 80% for placing for 96 hours;
3) Taking out the sample, inspecting with the naked eyes after recovering at room temperature for two hours. The results are shown in Table 1.

### 2 Metal Texture

The surface metal effects of the products A1-A4 and CA1-CA2 were observed with the naked eyes, and the results are shown in Table 1.

TABLE 1

| | Salt spray test | Metal texture |
|---|---|---|
| A1 | The graph-text on the metal | Haying a metal |
| | substrate surface is intact. | texture |
| A2 | The graph-text on the metal | Haying a metal |
| | substrate surface is intact. | texture |
| A3 | The graph-text on the metal | Haying a metal |
| | substrate surface is intact. | texture |
| A4 | The graph-text on the metal | Haying a metal |
| | substrate surface is intact. | texture |
| CA1 | The graph-text on the metal | None of metal |
| | substrate surface is intact. | texture |
| CA2 | The graph-text on the metal | None of metal |
| | substrate surface is incomplete. | texture |

It can be seen from Table 1 that the surface of the metal article obtained by the method of the present disclosure has intact graph-text and a metallic texture, and can obtain a graph-text effect of a 3D effect.

In the description of the present specification, the description with reference to the terms “one example”, “some examples”, “embodiment”, “specific embodiment”, or “some embodiments” and the like means the specific feature, structure, material, or characteristic described in connection with the example or embodiment are included in at least one example or embodiment of the present disclosure. In the present specification, the schematic representation of the terms referred above does not necessarily refer to the same example or embodiment. Furthermore, the specific feature, structure, material, or characteristic described may be combined in a suitable manner in any one or more examples or embodiments.

While the examples of the present invention have been shown and described, it can be understood by the person skilled in the art that various changes, modifications, replacement and variations can be made on these examples without departing from the spirit and scope of the present disclosure, and the scope of the disclosure is defined by the claims and equivalents thereof.

What is claimed is:

1. A metal article having decorative graph-text, wherein the metal article comprises a metal substrate having micropores on a surface of the metal substrate, thermal sublimation ink filled in a portion of the micropores, and a pore-sealing layer located on the surface of the metal substrate.

2. The metal article according to claim 1, wherein the micropores have a D50 from 1 nm to 100 μm.

3. The metal article according to claim 1, wherein the micropores have a depth from 10 nm to 100 μm.

4. The metal article according to claim 1, wherein the metal substrate is one of an aluminum alloy, a stainless steel, and a magnesium alloy.

5. A preparation method for a metal article having decorative graph-text, wherein the method comprises the following steps:
S1, performing a micropores treatment on a metal substrate to obtain the metal substrate having micropores on a surface of the metal substrate; and printing thermal sublimation ink onto thermal sublimation paper according to a desired graph-text shape;
S2, matching and attaching the graph-text on the thermal sublimation paper to the surface of the metal substrate;
S3, heating the thermal sublimation ink to cause the thermal sublimation ink to enter the micropores on the surface of the metal substrate, so as to form the decorative graph-text;
S4. removing the thermal sublimation paper and sealing pores, thereby obtaining the metal article having the decorative graph-text.

6. The preparation method according to claim 5 further comprises, before step S3, placing the metal substrate to which the thermal sublimation paper is attached into a sealing apparatus and vacuuming the sealing apparatus.

7. The preparation method according to claim 5, wherein the method of the micropores treatment is one or two combination treatment methods selecting from phosphating treatment, silanization treatment, anodizing treatment, and etching treatment.

8. The preparation method according to claim 5, wherein the micropores have a D50 from 1 nm to 100 μm.

9. The preparation method according to claim 5, wherein the micropores have a depth from 10 nm to 100 μm.

10. The preparation method according to claim 6, wherein the method for heating the thermal sublimation ink in step S3 is to bake the sealing apparatus, wherein the baking temperature is 80° C.-240° C., and the baking time is 2-360 minutes.

11. The preparation method according to claim 5, wherein the method for sealing pores is sealing pores with water or a sealing agent.

12. The preparation method according to claim 5 further comprising an oven-drying step after subjecting said metal substrate to said micropores treatment, wherein the oven-drying temperature is 80-100° C.

13. The preparation method according to claim 5, wherein the metal substrate is one of an aluminum alloy, stainless steel, and a magnesium alloy.

14. A metal article having decorative graph-text prepared by the preparation method according to claim 5.

15. The metal article according to claim 2, wherein the micropores have a depth from 10 nm to 100 μm.

16. The metal article according to claim 2, wherein the metal substrate is one of an aluminum alloy, a stainless steel, and a magnesium alloy.

17. The metal article according to claim 3, wherein the metal substrate is one of an aluminum alloy, a stainless steel, and a magnesium alloy.

18. The preparation method according to claim 6, wherein the method of the micropores treatment is one or two combination treatment methods selecting from phosphating treatment, silanization treatment, anodizing treatment, and etching treatment.

19. The preparation method according to claim 6, wherein the micropores have a D50 from 1 nm to 100 μm.

20. The preparation method according to claim 7, wherein the micropores have a D50 from 1 nm to 100 μm.
